(19) United States
(12) Patent Application Publication
(10) Pub. No.: US 2026/0195479 A1
(43) Pub. Date: Jul. 9, 2026

(54) ARTIFICIAL INTELLIGENCE FOR DATA ACCURACY

(71) Applicant: Truist Bank, Charlotte, NC (US)

(72) Inventors: Adesh Gupta, Charlotte, NC (US); Vikas Bhatnagar, Charlotte, NC (US)

(73) Assignee: Truist Bank, Charlotte, NC (US)

(21) Appl. No.: 19/014,107

(22) Filed: Jan. 8, 2025

Related U.S. Application Data
(63) Continuation of application No. 19/013,826, filed on Jan. 8, 2025.

(51) Int. Cl. G06F 21/62

(52) U.S. Cl. CPC G06F 21/6245

(57) ABSTRACT

A system can receive data that can include first confidential information about an interaction between a first entity and a second entity, the interaction involving a form having a first fields. The system can determine a target report based on the form. The system can identify second fields of the target report corresponding to the first fields. The second fields may include second confidential information about the interaction. The system can execute a first artificial intelligence model on the second fields to adjust the second confidential information. The system can determine an error rate for the adjusted second confidential information, and, in accordance with the error rate exceeding a threshold error rate, the system can execute a second artificial intelligence model on the second fields to further adjust the second confidential information. The system can adjust the target report.

### CROSS-REFERENCE TO RELATED APPLICATION

The present application is a continuation of U.S. application Ser. No. 19/013,826, filed Jan. 8, 2025, titled “ARTIFICIAL INTELLIGENCE FOR DATA ACCURACY,” the entirety of which is incorporated herein by reference.

### TECHNICAL FIELD

The present disclosure relates to artificial intelligence and, more particularly (although not necessarily exclusively), to artificial intelligence techniques that can be used to enhance data accuracy in various processes.

### BACKGROUND

Data may be created, transferred, consumed, or otherwise processed in various different ways. In some examples, the data may be confidential, may be protected, or may otherwise be private and not subject to intentional disclosures. During processing of data, errors may be introduced into the data that may cause official documents or other important documents to propagate the errors. These errors may be difficult to identify during processing of the data, during a quality control process, or during a combination thereof.

### SUMMARY

In some examples, a system can include a processor and a memory including instructions that can be executed by the processor to cause the processor to perform various operations. The system can receive data that can include first confidential information about an interaction between a first entity and a second entity. The interaction can involve a form having a first plurality of fields for receiving the first confidential information. The system can determine a target report to generate based at least in part on the form and the first confidential information. The system can identify one or more second fields of the target report and corresponding to the first plurality of fields. The one or more second fields can include second confidential information about the interaction. The system can execute a first artificial intelligence model on the one or more second fields to adjust the second confidential information. The system can determine an error rate for the adjusted second confidential information. The system can, in accordance with the error rate exceeding a threshold error rate, execute a second artificial intelligence model on the one or more second fields to further adjust the second confidential information. The system can adjust the target report using the adjusted second confidential information or the further adjusted second confidential information.

In additional examples, a method involving artificial intelligence can be used to enhance data accuracy. The method can include receiving data that can include first confidential information about an interaction between a first entity and a second entity. The interaction may involve a form having a first plurality of fields for receiving the first confidential information. The method can include determining a target report to generate based at least in part on the form and the first confidential information. The method can include identifying one or more second fields of the target report and corresponding to the first plurality of fields. The one or more second fields can include second confidential information about the interaction. The method can include executing a first artificial intelligence model on the one or more second fields to adjust the second confidential information. The method can include determining an error rate for the adjusted second confidential information. The method can include, in accordance with the error rate exceeding a threshold error rate, executing a second artificial intelligence model on the one or more second fields to further adjust the second confidential information. The method can include adjusting the target report using the adjusted second confidential information or the further adjusted second confidential information.

In additional examples, a non-transitory computer-readable medium can include program code that can be executed by a processing device to cause the processing device to perform various operations. The operations can include receiving data that can include first confidential information about an interaction between a first entity and a second entity. The interaction can involve a form having a first plurality of fields for receiving the first confidential information. The operations can include determining a target report to generate based at least in part on the form and the first confidential information. The operations can include identifying one or more second fields of the target report and corresponding to the first plurality of fields. The one or more second fields can include second confidential information about the interaction. The operations can include executing a first artificial intelligence model on the one or more second fields to adjust the second confidential information. The operations can include determining an error rate for the adjusted second confidential information. The operations can include, in accordance with the error rate exceeding a threshold error rate, executing a second artificial intelligence model on the one or more second fields to further adjust the second confidential information. The operations can include adjusting the target report using the adjusted second confidential information or the further adjusted second confidential information.

### BRIEF DESCRIPTION OF THE DRAWINGS

FIG. 1 is a block diagram of an example of a computing environment including a digital environment for using artificial intelligence to enhance data accuracy according to some implementations of the present disclosure.

FIG. 2 is a block diagram of an example of a computing system that can be used to enhance data accuracy using artificial intelligence according to some implementations of the present disclosure.

FIG. 3 is a flowchart of a process for enhancing data accuracy using artificial intelligence according to some implementations of the present disclosure.

FIG. 4 is a flowchart of a process for enhancing data security using artificial intelligence according to some implementations of the present disclosure.

### DETAILED DESCRIPTION

Certain aspects and features relate to artificial intelligence techniques for enhancing data accuracy. Additionally or alternatively, certain aspects and features relate to artificial intelligence techniques for enhancing data security. The data accuracy, the data security, or a combination thereof may relate to one or more interactions between a first entity, such as a user entity, and a second entity such as a provider entity. For example, the data accuracy of the interaction may involve an accuracy of data used to complete the interaction, to conduct a quality control analysis on the interaction, to report the interaction to a third party, or the like. Additionally or alternatively, the data security may involve a security of data used to complete the interaction, to conduct a quality control analysis on the interaction, to report the interaction to a third party, or the like. The data accuracy may represent an accuracy, or an error rate present in, the data, and the data security may represent a security level of the data. The artificial intelligence techniques can involve applying one or more artificial intelligence models, such as machine-learning models, large language models, generative artificial intelligence models, etc., to data associated with the interaction to enhance data accuracy, data security, and the like with respect to the interaction or with respect to one or more operations performed based on the interaction. For example, a target report can be generated based on the interaction, and an artificial intelligence model may be applied to the target report to enhance accuracy, security, and the like of the target report before being used for a subsequent interaction.

In some examples, interactions can take place between a user entity and a provider entity. The interactions can include the user entity requesting resources, such as real-world resources, digital or computing resources, potential resources, other suitable types of resources, or any combination thereof. To facilitate the interactions, the user entity may provide various types and amounts of data to the provider entity or to a third party associated with the provider entity. The data provided by the user entity may include confidential information, which may include personally identifiable information. In some examples, the confidential information can include a name of the user entity, an address of the user entity, a phone number of the user entity, an identification number of the user entity, other suitable confidential information useful for facilitating the interactions, or any combination thereof. The interactions may be completed, or the interactions may be pending, after the user entity provides the data. While the interactions are pending, or after interactions are complete, the provider entity may use the data provided by the user entity, or may use data otherwise associated with the user entity, to generate a target report that can be used to facilitate a separate interaction from the interactions between the user entity and the provider entity. For example, the target report may be transmitted to a third party that may use the target report to initiate the separate interaction involving the provider entity or involving the user entity. In a particular example, the target report may be or include a compliance report that can be used to determine whether to initiate disciplinary measures against the provider entity, whether to initiate corrective actions involving the provider entity or the user entity, whether to approve licenses or certifications for the provider entity, whether to initiate an interaction with the provider entity to approve the interactions between the user entity and the provider entity, etc.

In some examples, the target report may be analyzed using one or more artificial intelligence models included in a set of artificial intelligence models. The set of artificial intelligence models may include any suitable types of artificial intelligence models such as machine-learning models, large language models, generative artificial intelligence models, and the like, or combinations thereof. Each artificial intelligence model of the set of artificial intelligence models may be trained according to at least a portion of the target report. For example, the target may include one or more fields for receiving information corresponding with the data provided by the user entity to facilitate an interaction between the user entity and the provider entity. The one or more fields may each be configured to receive particular information such as different confidential information. For example, a first field of the one or more fields may be designed, arranged, or otherwise configured to receive a name of the user entity, a second field of the one or more fields may be designed, arranged, or otherwise configured to receive an identification number or sequence of the user entity, and so on.

A first artificial intelligence model of the set of artificial intelligence models may be trained to receive data from the first field, a second artificial intelligence model of the set of artificial intelligence models may be trained to receive data from the second field, and so on. The training data may be field-specific. For example, the first artificial intelligence model may be trained on data specific to the first field, such as name-based training data, the second artificial intelligence model may be trained on data specific to the second field, such as identification number-based training data, and so on. Additionally or alternatively, the training data for each artificial intelligence model of the set of artificial intelligence models may include structural data about corresponding fields. The structural data may include one or more locations of the corresponding fields on the target report, one or more sizes of the corresponding fields on the target report, one or more expected amounts or types of data for the corresponding fields, and the like.

The set of artificial intelligence models may be trained to adjust data included in the target report. For example, the set of artificial intelligence models may be trained to determine an error rate of the data included in the one or more fields of the target report. The set of artificial intelligence models may compare the data included in the one or more fields of the target report to corresponding fields of a form used to initiate or facilitate an interaction between the user entity and the provider entity. The set of artificial intelligence models can determine if the error rate exceeds a threshold error rate for the data, and, if so, the set of artificial intelligence models can adjust the data to lower the error rate below the threshold error rate. In some examples, the set of artificial intelligence models may be executed iteratively until the error rate no longer exceeds the threshold error rate.

Additionally or alternatively, the set of artificial intelligence models may be trained to determine a likelihood that the data included in the target report, or in other locations, is secure. For example, the set of artificial intelligence models may determine a likelihood of whether each field of the one or more fields is likely to be unintentionally disclosed and may determine a likelihood of whether an unintentional disclosure of the field may violate any third party rules. Based on the determined likelihoods, the set of artificial intelligence models may automatically mask or at least partially mask some of the data included in the field to enhance data security and privatization.

In some examples, the set of artificial intelligence models may be constructed using a computer-based tool. The computer-based tool may be or include a user interface, such as a user interface that can generate robotic automated processes, programs, or models, etc., and the user interface may be used to construct the set of artificial intelligence models or any subset thereof. Constructing the set of artificial intelligence models may include selecting a particular type of artificial intelligence to use as a base for the set of artificial intelligence models, may include fine-tuning or training each artificial intelligence model of the set of artificial intelligence models using different training datasets, etc. For example, the computer-based tool may be used to identify a large language model most useful for enhancing data accuracy, data security, or a combination thereof, and the computer-based tool may be used to train the large language model on relevant training data for enhancing data accuracy, data security, or a combination thereof for the target report.

The techniques described herein improve one or more technical fields. For example, the techniques described herein improve the technical field of data accuracy, data security, and the like. By specifically training a particular artificial intelligence model on specific training data relating to the target report, the target report can be adjusted to reduce the error rate, sometimes to zero, of the data included in the target report to rates lower than those associated with other techniques. Additionally or alternatively, by specifically training a particular artificial intelligence model on specific training data relating to the target report, the target report can be made more secure, compared to other target reports generated or otherwise processed via other techniques, which can lead to a reduced risk of unintentional disclosure of confidential information, etc.

These illustrative examples are given to introduce the reader to examples of the general subject matter discussed here and are not intended to limit the scope of the disclosed concepts. In the following description, for the purposes of explanation, specific details are set forth in order to provide a thorough understanding of various implementations and examples. Various implementations may be practiced without these specific details. The figures and description are not intended to be restrictive.

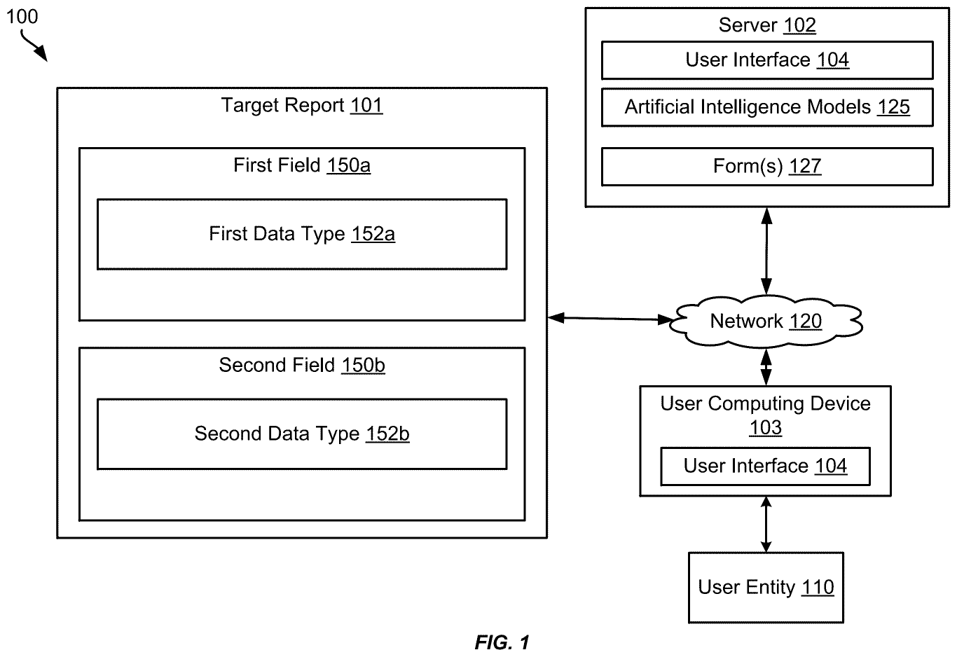

FIG. 1 is a block diagram of an example of a computing environment 100 including a digital environment for using artificial intelligence to enhance data accuracy according to some implementations of the present disclosure. In some examples, the computing environment 100 can be used to enhance data accuracy using artificial intelligence, to enhance data security using artificial intelligence, or a combination thereof. The computing environment 100 may improve (i) data security by using artificial intelligence to monitor digital interaction requests and progress for unauthorized or unsuccessful previously executed interactions or masking requests, (ii) interaction initiation accuracy by providing customizable user interface such as user interface 104, and (iii) data accuracy by using artificial intelligence to make adjustments to data used in a target report or in other suitable subsequent interactions. The services provided by, controlled, or otherwise facilitated by server 102 can be associated with one or more entities, such as users, providers, organizations, devices, other suitable entities, or any combination thereof.

In some examples, the computing environment 100 can include a target report 101, the server 102, a user computing device 103, a user entity 110, and a network 120, though the computing environment 100 may include additional, alternative, or fewer components for providing functionality for the computing environment 100. The target report 101, the server 102, the user computing device 103, and any other component or computing device of the computing environment 100 may be communicatively coupled with one another, or with a subset of one another, via the network 120. Additionally or alternatively, the user entity 110 may communicate with the user computing device 103 via one or more input or output devices such as a microphone, a keyboard, a computer mouse, a touchscreen display, and the like.

The user entity 110 can use the user computing device 103 to access the network 120 to request resources, information, access, or the like from the server 102. For example, the user computing device 103 can receive natural language input, indications of selections and the like from the user entity 110, and the user computing device 103 can convert the received input into a call, such as an API call or a REST call, that can be made via the network 120. In some examples, the network 120 can include any type of network that can support data communications using any of a variety of commercially available protocols. Examples of the network 120 can include TCP/IP (transmission control protocol/Internet protocol), SNA (systems network architecture), IPX (Internet packet exchange), Secure Sockets Layer (SSL) or Transport Layer Security (TLS) protocols, Hyper Text Transfer Protocol (HTTP) and Secure Hyper Text Transfer Protocol (HTTPS), Bluetooth®, Near Field Communication (NFC), and the like. In some examples, the network 120 may be or include a local area network (LAN) such as one based on Ethernet, Token-Ring or the like. The network 120 also may be or include a wide-area network, such as the Internet, or may include financial networks or banking networks, telecommunication networks such as a public switched telephone networks (PSTNs), cellular or other wireless networks, satellite networks, television/cable networks, or virtual networks such as an intranet or an extranet, etc. Infrared and wireless networks, such as those using the Institute of Electrical and Electronics (IEEE) 802.11 protocol suite or other wireless protocols, may also be included in the communication networks.

The server 102 can receive the call from the user computing device 103 and can provide a user interface 104, and any user interface pages or sub-pages included therein, to the user computing device 103. The user interface 104 can include graphical objects, which may be selected or may be static, and can include other suitable features for a user interface. The graphical objects may be or include features that can be displayed on the user interface 104 and that may or may not be interactive, that may or may not be dynamic, such as changing after a predetermined amount of elapsed time, etc. For example, the graphical objects may include design features of the user interface 104, may include logos, emblems, trademarks, etc., and the like. The user interface 104 may additionally or alternatively include interactive elements that may be or include features that can be displayed on the user interface 104 and with which can be interacted. For example, the user entity 110 may use the user computing device 103 to interact, for example by clicking or otherwise suitably indicating selection, with one or more of the interactive elements. In some examples, the interactive elements may include one or more subsets of possible interactive elements that can be provided via the user interface 104. The one or more subsets of possible interactive elements can include a set of first interactive elements and a set of second interactive elements. The set of first interactive elements can be or include interactive elements that correspond to or otherwise represent a particular potential interaction or service of a set of services. Additionally or alternatively, the set of second interactive elements can be or include interactive elements that correspond to or otherwise represent particular data or types of data associated with a selected potential interaction or service of the set of services.

In response to receiving a request from the user computing device 103 to initiate an interaction between a provider entity, which may provide or maintain the server 102, and the user entity 110, the server 102 can verify an authenticity of the request. For example, the request may be or include an authentication request with authentication data, and the server 102 can request an authentication, such as an enhanced or more scrutinized authentication, from the user entity 110, for example to verify an identity of the user entity 110 or a validity of the received request. For example, the server 102 may request that the user entity 110 provide multifactor authentication (MFA) as the authentication to verify the identity of the user entity 110. Providing the MFA can involve inputting one or more additional or alternative authentication factors than those included in the received request. Examples of the authentication factors can include a username, password, biometric marker, personal identification number (PIN), authentication code, one-time password authentication, or any combination thereof. In some examples, the user computing device 103 may include an authenticator application installed on the user computing device 103 to provide the MFA as the authentication to the server 102.

In response to authenticating the request or otherwise determining that the request is legitimate, the server 102 can provide the user interface 104 to the user computing device 103. In some examples, the server 102 can access information relating to the requested interaction to populate a first user interface page of the user interface 104. The accessed information may be or include known information about the user entity 110 or information previously provided by the user entity 110. In some examples, the user entity 110 can provide confidential information via the user interface 104 to facilitate or otherwise propagate a process for performing the requested interaction. The server 102 can generate a list of interactive elements to be provided to the user entity 110 via the user interface 104 based at least in part on the requested interaction, the confidential information, or a combination thereof. The server 102 can transmit the user interface 104 to the user computing device 103 to allow the user entity 110 to provide the confidential information or to otherwise facilitate the requested interaction. In response to using the user interface 104 to initiate or complete the requested interaction, the confidential information, and other information, provided by the user entity 110 via the user interface 104 may be stored such as on, or otherwise accessible to, the server 102. For example, the user entity 110 may provide the confidential information via one or more forms 127 that can include one or more fields for receiving the confidential information. The one or more forms 127 may be configured to receive confidential information such as a name of the user entity 110, an address of the user entity 110, an identification number or sequence of the user entity 110, etc.

In some examples, the data provided via the user interface 104 can be used to generate the target report 101 and any fields thereof. For example, the server 102 can access the data provided via the user interface 104 to generate the target report 101, to perform processing on the target report 101, to compare the target report 101 to other reports or forms, such as the one or more forms 127, or a combination thereof. The server 102 may use the data provided via the user interface 104 as a control to enhance data accuracy or data security of data included in the target report 101. In some examples, the server 102 may include one or more artificial intelligence models 125 that can be used for generating or adjusting the target report 101. The server 102 may provide the data provided via the user interface 104, such as via the one or more forms 127, as input to the one or more artificial intelligence models 125 to cause the one or more artificial intelligence models 125 to provide output for generating or adjusting the target report 101.

The one or more artificial intelligence models 125 may be or include different types of artificial intelligence models. For example, the one or more artificial intelligence models 125 may include one or more generative models, one or more large language models, one or more machine-learning models, one or more other suitable types of artificial intelligence models, or any combination thereof. Additionally or alternatively, the one or more artificial intelligence models 125 may be fine-tuned or otherwise trained to provide the processing described herein. For example, the one or more artificial intelligence models 125 may be trained using training data specific to the fields included in the one or more forms 127, included in the target report 101, or included in a combination thereof. In a particular example, a first artificial intelligence model of the one or more artificial intelligence models 125 may be trained using training data associated with a first field 150a of the target report 101 having a first data type 152a, and a second artificial intelligence model of the one or more artificial intelligence models 125 may be trained using training data associated with a second field 150b of the target report 101 having a second data type 152b. The first data type 152a may be a name, and the second data type 152b may be an identification number, though the first data type 152a and the second data type 152b may be any additional or alternative data type for facilitating the target report 101.

In some examples, each artificial intelligence model of the one or more artificial intelligence models 125 may be or include a large language model or other suitable artificial intelligence model that can receive natural language input and generate natural language output. The one or more artificial intelligence models 125 may be resident on memory or other computing hardware associated with the server 102 or in other locations that are accessible by the server 102. The one or more artificial intelligence models 125 may be trained using one or more training datasets that include labeled or unlabeled natural language data points. In some examples, the training datasets may include previously transmitted communications, which may include confidential information of a specific nature or type, associated with the user entity 110. The trained one or more artificial intelligence models may be configured to receive input data, such as confidential data included in the target report 101 or in the one or more forms 127, and to generate one or more outputs that can include generation of the target report 101, recommendations for adjustments to the target report 101, automatic adjustments to the target report 101, etc. In some examples, based on the output from the one or more artificial intelligence models 125, the server 102 may automatically determine adjust the target report 101, may automatically transmit the target report 101, may automatically initial a subsequent interaction based on the target report 101, or may take other suitable automatic actions.

In some examples, the user interface 104 may be used to construct the one or more artificial intelligence models 125. The provider entity, or other suitable entity associated with the server 102, may use the user interface 104 to construct, configure, train, or otherwise generate the one or more artificial intelligence models 125. For example, the user interface 104 may be used to select particular training datasets to use for training the one or more artificial intelligence models 125, the user interface 104 may be used to select particular types of artificial intelligence models to use as a base for the one or more artificial intelligence models 125, and the like. The one or more artificial intelligence models 125 may be generated prior to being used to generate, adjust, or otherwise process the target report 101.

In some examples, the server 102 may be communicatively coupled, such as via the network 120, with a digital environment that may provide the target report 101. The digital environment may be provided by a separate entity from the provider entity that provides the server 102, though in some examples, the digital environment may be provided by the provider entity. In some examples, the digital environment may be integrated with or otherwise hosted on the server 102 such as included in software or hardware of the server 102, or vice versa. The server 102 can generate a call, such as an API call, a query, a REST call, or the like, and can transmit the call to the digital environment to generate or otherwise interact with the target report 101. The call may include confidential information, such as the information provided via the one or more forms 127, for generating the target report 101, for analyzing, such as via an artificial intelligence model of the one or more artificial intelligence models 125, data included in the target report 101, for adjusting the target report 101, or for performing other suitable operation. Additionally or alternatively, the call may include an indication of a particular backend processing service to use for generating, interacting with, or analyzing, data associated with the target report 101. The server 102 may determine which backend processing service to use based on the target report 101, the interaction between the user entity 110 and the provider entity, based on the available confidential information, or the like.

The target report 101 may include various fields that can be filled with confidential information. For example, and as illustrated in FIG. 1, the target report 101 can include a first field 150a and a second field 150b, though other suitable numbers, such as one or more than two, of fields are possible for the target report 101. The first field 150a may be configured to receive a first type of data, such as the first data type 152a, associated with the interaction, and the second field 150b may be configured to receive a second type of data, such as the second data type 152b, associated with the interaction. Receiving a type of data may involve receiving input, such as via a human-computer interaction or directly from a computer, that is positioned or otherwise stored in a respective field. For example, the first field 150a may receive data of the first data type 152a that includes a first type of confidential information, such as a name or address associated with the user entity 110, and the second field 150b may receive data of the second data type 152b such as an identification number or sequence or a risk score associated with the user entity 110.

Subsequent to the target report 101 being finalized, the server 102 can determine a particular process for initiating a separate interaction from the interaction between the user entity 110 and the provider entity. For example, the server 102 can identify an interaction to initiate between the provider entity and a third party for facilitating service by the provider entity. Additionally or alternatively, the server 102 can determine a set of data, documents, information, and the like that can be used to initiate or complete the separate interaction. In some examples, to determine the separate interaction or the set of data, etc., the server 102 can analyze the target report 101, or any fields included therein, to identify a type of account associated with the separate interaction, to identify a progress of the interaction between the user entity 110 and the provider entity, to identify a type or other classification associated with a previously executed interaction, and the like. The server 102 can use a result of the analysis to determine the separate interaction, to determine the set of data, and the like. Additionally or alternatively, the server 102 can use the result of the analysis to control communication between the server 102 and a separate computing device, for example to initiate or facilitate the separate interaction.

Although FIG. 1 illustrates a particular number and arrangement of components, FIG. 1 is intended to be illustrative and non-limiting. Other examples may include more components, fewer components, different components, or a different arrangement of the components shown in FIG. 1. Any suitable arrangement of the depicted components is contemplated herein.

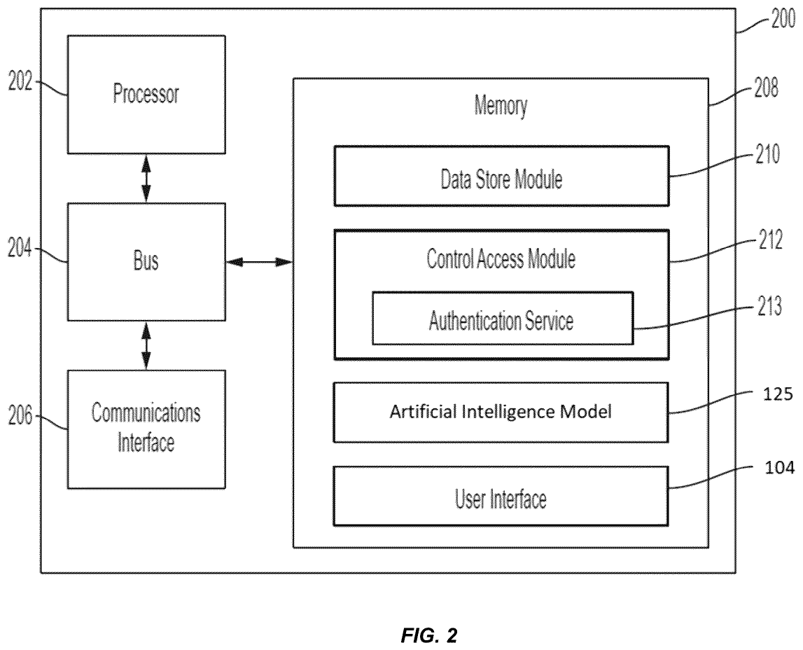

FIG. 2 is a block diagram of an example of a computing system 200, such as the server 102, that can be used to enhance data accuracy using artificial intelligence according to some implementations of the present disclosure. The computing system 200 may be a network device and may include a processor 202, a bus 204, a communications interface 206, and a memory 208. In some examples, the components illustrated in FIG. 2 may be integrated into a single structure. For example, the components can be within a single housing. In other examples, the components illustrated in FIG. 2 can be distributed, such as in separate housings, and in electrical communication with each other.

The processor 202 may execute one or more operations for implementing various examples and embodiments described herein. The processor 202 can execute instructions stored in the memory 208 to perform the operations. The processor 202 can include one processing device or multiple processing devices. Non-limiting examples of the processor 202 include a Field-Programmable Gate Array (“FPGA”), an application-specific integrated circuit (“ASIC”), a microprocessor, etc.

The processor 202 may be communicatively coupled to the memory 208 via the bus 204. The memory 208, such as non-volatile memory, may include any type of memory device that retains stored information when powered off. Examples of the memory 208 can include electrically erasable and programmable read-only memory (“EEPROM”), flash memory, or any other type of non-volatile memory. In some examples, at least some of the memory 208 may include a medium from which the processor 202 can read instructions. A computer-readable medium may include electronic, optical, magnetic, or other storage devices capable of providing the processor 202 with computer-readable instructions or other program code. Examples of a computer-readable medium can include magnetic disk(s), memory chip(s), ROM, random-access memory (“RAM”), an ASIC, a configured processor, optical storage, or any other medium from which a computer processor may read instructions. The instructions may include processor-specific instructions generated by a compiler or an interpreter from code written in any suitable computer-programming language, including, for example, C, C++, C#, Java, Python, Perl, R, etc.

The communications interface 206 may interface other network devices or network-capable devices to analyze and receive information related to accessing functions of an application. Information received from the communications interface 206 may be sent to the memory 208 via the bus 204. The memory 208 can store any information received from the communications interface 206.

The memory 208 may include program code for determining user interface pages, and data to embed therein, to provide for the user interface 104. The program code may cause the computing system 200, or any component within the computing system 200, to make calls, such as API calls, to separate computing devices or digital environments to provide the user interface 104, to enhance data accuracy or data security, etc. The memory 208 may additionally include program code for a data store module 210, a control access module 212, one or more artificial intelligence models 125, and the user interface 104. In some examples, the one or more artificial intelligence models 125 may be trained large language models or other suitable trained artificial intelligence models configured to receive natural language input and generate natural language output. The user interface 104 may allow the computing system 200 to receive user input that can be used to perform functions. Examples of functions can include generating the target report 101, adjusting the target report 101, initiating a subsequent or separate interaction based on the target report 101, etc.

The data store module 210 may store information, such as username and password, security information, interaction data, etc., relating to a user account for a number of users and client devices, such as the user computing device 103, including originating IP addresses of login attempts, browser settings of login attempts, etc. The control access module 212 may include or be communicatively coupled to an authentication service 213 and may validate whether a user access attempt, such as by the user entity 110, has been successfully authenticated after a user has entered correct account login information. In some cases, the control access module 212 may additionally or alternatively determine that access to the target report 101 is requested. The results from the control access module 212 may be used by an API associated with the computing system 200 to request access to a user account, to determine an authentication process to perform with respect to the requested function, to authenticate the requested function (e.g., via the determined authentication process), and to cause the requested function to be executed. Additionally or alternatively, the results from the control access module 212 may be used by the user interface 104 or the computing system 200 to send a request for data or to send a request to execute a function to an API, for example for accessing or interacting with at least a portion of the target report 101.

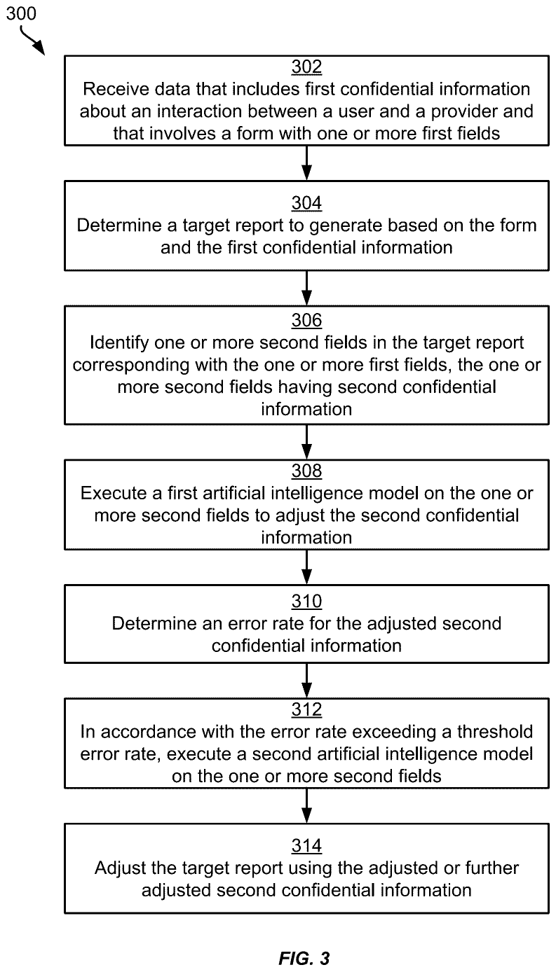

FIG. 3 is a flowchart of a process 300 for enhancing data accuracy using artificial intelligence according to some implementations of the present disclosure. In some examples, the server 102, or components such as the processor 202, or other components of the computing system 200, can perform one or more of the steps illustrated in FIG. 3. In other examples, the processor 202 can implement more steps, fewer steps, different steps, or a different order of the steps illustrated in FIG. 3. The steps of FIG. 3 are described below with reference to components discussed above in FIGS. 1-2.

At block 302, data is received. The data can include first confidential information about an interaction between a user entity, such as the user entity 110, and a provider entity such as a provider entity that may provide the server 102, etc. In some examples, the interaction may involve a form such as the one or more forms 127. The form may include a first set of fields that may be configured to receive the first confidential information. For example, the first set of fields may include one or more fields that include labels guiding a user of the form to enter particular information, such as the first confidential information, in respective fields of the one or more fields. In some examples, the first confidential information may be received during a process for initiating or completing the interaction between the user entity and the provider entity. That is, the operations described with respect to the process 300 may be performed while the interaction is being executed between the user entity and the provider entity, or the operations described with respect to the process 300 may be performed subsequent to the interaction being executed between the user entity and the provider entity.

At block 304, a target report, such as the target report 101, is determine. In some examples, the server 102 can determine to generate the target report 101 based at least in part on the form used to receive the first confidential information, based at least in part on the first confidential information itself, or based at least in part on a combination thereof. The server 102 may determine to generate the target report 101 by comparing the first set of fields of the form to a second set of fields of the target report 101. That is, the server 102 may select the target report 101 to generate based on selecting the second set of fields of the target report 101 as the most similar fields to the first set of fields of the form.

At block 306, one or more second fields in the target report 101 are identified. The one or more second fields in the target report 101 may be all of the fields included in the target report 101 or may be or include a subset of the fields included in the target report 101. Additionally or alternatively, the one or more second fields may correspond with the first set of fields included in the form. The one or more second fields may include second confidential information that may be similar or identical to, or otherwise relate to, the first confidential information of the form. For example, the one or more second fields may be configured to receive the same or similar confidential information as the set of first fields. In a particular example, if the set of first fields include a name field, an address field, and an identification field, the one or more second fields may include a name-type field, and address-type field, and an identification-type field, even if identical fields are not present or available in the target report.

In some examples, the server 102 may generate, or cause to be generated, the target report based on available information about the interaction between the user entity and the provider entity. There may be multiple different data points available representing the interaction, and the server 102 may use each data point of the multiple different data points, or any subset thereof, to generate the target report. For example, there may be various data gathering steps along a process for completing the interaction between the user entity and the provider entity. Gathering the data points may involve scanning handwritten forms, importing or transferring digital forms, manual entry of data by a separate entity, such as a human, etc. The gathered data may be imported at approximately the same time to generate the target report. Additionally or alternatively, since there may be multiple points in time at which data may be gathered for the interaction, one or more errors may have been inadvertently introduced into the gathered data, and the one or more errors may persist into the initially generated target report.

At block 308, a first artificial intelligence model is executed on the target report. In some examples, the one or more artificial intelligence models may be executed and applied to the target report to address the one or more errors that may have been introduced to the initially generated target report. For example, the first artificial intelligence model may be applied to a first field of one or more fields of the target report to determine whether the data included in the first field is likely to include an error. The first artificial intelligence model may generate a likelihood or a different type of score to represent the likelihood that the data included in the first field includes an error. In some examples, the first artificial intelligence model may receive data relevant to the first field. That is, if the first field is a name field, the first artificial intelligence model may receive name-based data that may have been gathered throughout the process for executing or initiating the interaction. The data input into the first artificial intelligence model may be approximately the same. For example, the data input into the first artificial intelligence may include “John Smith”, “John A. Smith”, and “John A Smith”, etc., and the data included in the first field may include “John A. Smith”. The first artificial intelligence model may generate a likelihood that indicates the data included in the first field is likely to be correct. The likelihood may exceed a threshold likelihood.

In other examples, The data input into the first artificial intelligence model may include, among other similar data points, “Jon A Smyth”, and the first field may include “John A. Smith”. The likelihood generated by the first artificial intelligence model may indicate that an error is likely included in the first field. For example, the likelihood may not exceed the threshold likelihood. The first artificial intelligence model may proceed with adjusting the data included in the first field to at least approximately match the input data. That is, the first artificial intelligence model may adjust the data included in the first field to adjusted data that does exceed the threshold likelihood for indicating that the adjusted data likely does not include an error.

At block 310, an error rate is determined for the target report. For example, each artificial intelligence model of the one or more artificial intelligence models, or any subset thereof, may be executed on the initially generated target report to determine whether one or more errors are likely to exist in the one or more fields of the target report. The error rate may be determined, for example by the server 102 or by at least one artificial intelligence model of the one or more artificial intelligence models, based on the likelihoods generated for each field of the one or more fields. The likelihoods may be concatenated or otherwise suitably combined to determine the error rate.

At block 312, a second artificial intelligence model of the one or more artificial intelligence models is executed. In some examples, the error rate may exceed a threshold error rate, and the server 102 can determine to execute the second artificial intelligence model to reduce the error rate. The above-described sequence can be iteratively performed until the error rate does not exceed the threshold error rate. For example, if the second artificial intelligence model is applied to a second field of the one or more fields to adjust the data included in the second field, and the error rate for the target report still exceeds the error rate, the server 102 may execute a third artificial intelligence model on a third field, and so on. In some examples, each artificial intelligence model of the one or more artificial intelligence models, or any subset thereof, may be applied to more than one field. That is, a particular artificial intelligence model of the one or more artificial intelligence models may be configured to receive data about more than one field of the one or more fields and may be configured to adjust data included in the more than one field, for example to reduce the error rate of the target report.

At block 314, the target report is adjusted based on the adjusted data, the further adjusted data, or a combination thereof. Any data adjusted by the one or more artificial intelligence models may be inserted into the target report for adjusting the target report. Additionally or alternatively, adjusting the target report may involve or yield a lower error rate for data included in the adjusted target report compared to an error rate of the initially generated target report. The adjusted target report may be used to initiate a separate interaction that may involve the user entity or the provider entity. For example, the server 102 can control a subsequent interaction using the adjusted target report, and the subsequent interaction can include a second interaction that is different than the interaction between the user entity and the provider entity.

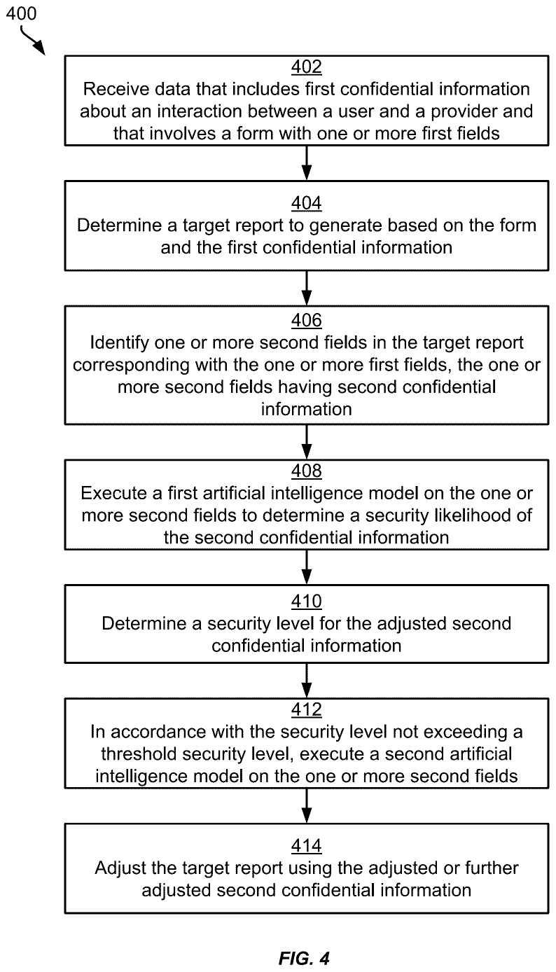

FIG. 4 is a flowchart of a process 400 for enhancing data security using artificial intelligence according to some implementations of the present disclosure. In some examples, the server 102, or components such as the processor 202, or other components of the computing system 200, can perform one or more of the steps illustrated in FIG. 4. In other examples, the processor 202 can implement more steps, fewer steps, different steps, or a different order of the steps illustrated in FIG. 4. The steps of FIG. 4 are described below with reference to components discussed above in FIGS. 1-2.

At block 402, data is received. The data can include first confidential information about an interaction between a user entity, such as the user entity 110, and a provider entity such as a provider entity that may provide the server 102, etc. In some examples, the interaction may involve a form such as the one or more forms 127. The form may include a first set of fields that may be configured to receive the first confidential information. For example, the first set of fields may include one or more fields that include labels guiding a user of the form to enter particular information, such as the first confidential information, in respective fields of the one or more fields. In some examples, the first confidential information may be received during a process for initiating or completing the interaction between the user entity and the provider entity. That is, the operations described with respect to the process 300 may be performed while the interaction is being executed between the user entity and the provider entity, or the operations described with respect to the process 300 may be performed subsequent to the interaction being executed between the user entity and the provider entity.

At block 404, a target report, such as the target report 101, is determine. In some examples, the server 102 can determine to generate the target report 101 based at least in part on the form used to receive the first confidential information, based at least in part on the first confidential information itself, or based at least in part on a combination thereof. The server 102 may determine to generate the target report 101 by comparing the first set of fields of the form to a second set of fields of the target report 101. That is, the server 102 may select the target report 101 to generate based on selecting the second set of fields of the target report 101 as the most similar fields to the first set of fields of the form.

At block 406, one or more second fields in the target report 101 are identified. The one or more second fields in the target report 101 may be all of the fields included in the target report 101 or may be or include a subset of the fields included in the target report 101. Additionally or alternatively, the one or more second fields may correspond with the first set of fields included in the form. The one or more second fields may include second confidential information that may be similar or identical to, or otherwise relate to, the first confidential information of the form. For example, the one or more second fields may be configured to receive the same or similar confidential information as the set of first fields. In a particular example, if the set of first fields include a name field, an address field, and an identification field, the one or more second fields may include a name-type field, and address-type field, and an identification-type field, even if identical fields are not present or available in the target report.

In some examples, the server 102 may generate, or cause to be generated, the target report based on available information about the interaction between the user entity and the provider entity. There may be multiple different data points available representing the interaction, and the server 102 may use each data point of the multiple different data points, or any subset thereof, to generate the target report. For example, there may be various data gathering steps along a process for completing the interaction between the user entity and the provider entity. Gathering the data points may involve scanning handwritten forms, importing or transferring digital forms, manual entry of data by a separate entity, such as a human, etc. The gathered data may be imported at approximately the same time to generate the target report. Additionally or alternatively, since there may be multiple points in time at which data may be gathered for the interaction, one or more errors may have been inadvertently introduced into the gathered data, and the one or more errors may persist into the initially generated target report. Additionally or alternatively, along the processing steps, levels of security or privacy may vary. For example, during a pre-processing step of the process, personally identifiable information may be required to be masked or otherwise privatized. Additionally or alternatively, during a quality control step of the process, the personally identifiable information may be required to be masked or otherwise privatized, etc.

At block 408, a first artificial intelligence model is executed on the target report. In some examples, the one or more artificial intelligence models may be executed and applied to the target report to address the varying levels of security that may be required for the target report during processing or associated steps. For example, the first artificial intelligence model may be applied to a first field of one or more fields of the target report to determine whether the data included in the first field is likely to be required to be masked or privatized and whether the data included in the first field is likely to be unintentionally disclosed. The first artificial intelligence model may generate a likelihood or a different type of score to represent the likelihood that the data included in the first field may be required to be privatized or may be unintentionally disclosed. In some examples, the first artificial intelligence model may receive data relevant to the first field. That is, if the first field is a name field, the first artificial intelligence model may receive name-based data that may have been gathered throughout the process for executing or initiating the interaction. Based on the input data, the first artificial intelligence model may determine a first likelihood that a mask or other privatization may required for the first field or data thereof, and the first artificial intelligence model may determine a second likelihood that the data of the first field may be unintentionally disclosed. Based on the first likelihood and the second likelihood, the first artificial intelligence model may adjust the data of the first field by masking the data, redacting the data, or otherwise enhancing a security level of the data.

At block 410, a security level is determined for the target report. Each artificial intelligence model of the one or more artificial intelligence models may be executed to determine a security level associated with each field of the one or more fields. The determined security levels may indicate whether the data included in the target report are properly privatized or whether the data included in the target report are likely to be unintentionally disclosed. The one or more artificial intelligence models, or the server 102, may generate the security level as a score or other value that indicates the security level of the target report.

At block 412, a second artificial intelligence model of the one or more artificial intelligence models is executed. In some examples, the security level may not exceed a threshold security level, indicating that the target report is not as secure as intended, and the server 102 can determine to execute the second artificial intelligence model to increase the security level. The above-described sequence can be iteratively performed until the security level exceeds the threshold security level. For example, if the second artificial intelligence model is applied to a second field of the one or more fields to adjust the data included in the second field, and the security level for the target report still does not exceed the error rate, the server 102 may execute a third artificial intelligence model on a third field, and so on. In some examples, each artificial intelligence model of the one or more artificial intelligence models, or any subset thereof, may be applied to more than one field. That is, a particular artificial intelligence model of the one or more artificial intelligence models may be configured to receive data about more than one field of the one or more fields and may be configured to adjust data included in the more than one field, for example to enhance the security level of the target report.

At block 414, the target report is adjusted based on the adjusted data, the further adjusted data, or a combination thereof. Any data adjusted by the one or more artificial intelligence models may be inserted into the target report for adjusting the target report. Additionally or alternatively, adjusting the target report may involve or yield a higher data mask or privatization rate for data included in the adjusted target report compared to a data privatization or mask rate of the initially generated target report. The adjusted target report may be used to initiate a separate interaction that may involve the user entity or the provider entity. For example, the server 102 can control a subsequent interaction using the adjusted target report, and the subsequent interaction can include a second interaction that is different than the interaction between the user entity and the provider entity.

Although the subject matter has been described in language specific to structural features or methodological acts, it is to be understood that the subject matter defined in the appended claims is not necessarily limited to the specific features or acts described above. Rather, the specific features and acts described above are disclosed only for the purpose of illustration and description and they are not intended to be exhaustive or to limit the disclosure to the precise forms disclosed. Modifications, adaptations, and uses thereof will be apparent to those skilled in the art without departing from the scope of the disclosure. For instance, any examples described herein can be combined with any other examples.

1. A system comprising:
a processor; and
a memory including instructions that are executable by the processor for causing the processor to perform operations comprising:
receiving data comprising first confidential information about an interaction between a first entity and a second entity, the interaction involving a first plurality of fields for receiving the first confidential information;
determining a target report to generate based at least in part on the first confidential information;
identifying one or more second fields of the target report and corresponding to the first plurality of fields, the one or more second fields comprising second confidential information about the interaction, the second confidential information different from the first confidential information;
executing, to generate adjusted second confidential information, a first artificial intelligence model on the one or more second fields to ascertain a security likelihood associated with the second confidential information;
determining a security level for the adjusted second confidential information based at least in part on the security likelihood;
in accordance with the security level not exceeding a threshold security value, executing, to generate further adjusted second confidential information, a second artificial intelligence model on the one or more second fields to adjust the security likelihood; and
adjusting the target report using the adjusted second confidential information or the further adjusted second confidential information.

2. The system of claim 1, wherein the first artificial intelligence model and the second artificial intelligence model are included in a plurality of artificial intelligence models, and wherein each artificial intelligence model of the plurality of artificial intelligence models corresponds with a different field of the one or more second fields.

3. The system of claim 2, wherein the operation of executing the first artificial intelligence model on the one or more second fields comprises, for each field of the one or more second fields:
identifying a particular artificial intelligence model of the plurality of artificial intelligence models that corresponds with the field; and
executing the particular artificial intelligence model on the field to determine a corresponding security level of data included in the field.

4. The system of claim 1, wherein the operations further comprise:
executing a third artificial intelligence model on the one or more second fields to adjust the second confidential information;
determining an error rate for the adjusted second confidential information; and
in accordance with the error rate exceeding a threshold error rate, executing a fourth artificial intelligence model on the one or more second fields to further adjust the second confidential information.

5. The system of claim 1, wherein the first artificial intelligence model and the second artificial intelligence model are included in a plurality of artificial intelligence models, wherein each artificial intelligence model of the plurality of artificial intelligence models are trainable on a separate training dataset of a plurality of training datasets, wherein each training dataset of the plurality of training datasets are specific to a corresponding field of the one or more second fields, and wherein the operations further comprise generating, using a computer service, the plurality of artificial intelligence models by training each artificial intelligence model of the plurality of artificial intelligence models using the plurality of training datasets.

6. The system of claim 1, wherein the first artificial intelligence model comprises a first large language model and the second artificial intelligence model comprises a second large language model, wherein the first large language model has a same base model as the second large language model, and wherein the first large language model is trainable using a first training process that is different than a second training process.

7. The system of claim 1, wherein the operations further comprise controlling a subsequent interaction using the adjusted target report, wherein the subsequent interaction comprises a second interaction that is different than the interaction between the first entity and the second entity, and wherein the subsequent interaction involves the first entity or the second entity.

8. A method comprising:
receiving data comprising first confidential information about an interaction between a first entity and a second entity, the interaction involving a first plurality of fields for receiving the first confidential information;
determining a target report to generate based at least in part on the first confidential information;
identifying one or more second fields of the target report and corresponding to the first plurality of fields, the one or more second fields comprising second confidential information about the interaction, the second confidential information different from the first confidential information;
executing, to generate adjusted second confidential information, a first artificial intelligence model on the one or more second fields to ascertain a security likelihood associated with the second confidential information;
determining a security level for the adjusted second confidential information based at least in part on the security likelihood;
in accordance with the security level not exceeding a threshold security value, executing, to generate further adjusted second confidential information, a second artificial intelligence model on the one or more second fields to adjust the security likelihood; and
adjusting the target report using the adjusted second confidential information or the further adjusted second confidential information.

9. The method of claim 8, wherein the first artificial intelligence model and the second artificial intelligence model are included in a plurality of artificial intelligence models, and wherein each artificial intelligence model of the plurality of artificial intelligence models corresponds with a different field of the one or more second fields.

10. The method of claim 9, wherein executing the first artificial intelligence model on the one or more second fields comprises, for each field of the one or more second fields:
identifying a particular artificial intelligence model of the plurality of artificial intelligence models that corresponds with the field; and
executing the particular artificial intelligence model on the field to determine a corresponding security level of data included in the field.

11. The method of claim 8, further comprising:
executing a third artificial intelligence model on the one or more second fields to adjust the second confidential information;
determining an error rate for the adjusted second confidential information; and
in accordance with the error rate exceeding a threshold error rate, executing a fourth artificial intelligence model on the one or more second fields to further adjust the second confidential information.

12. The method of claim 11, wherein the first artificial intelligence model and the second artificial intelligence model are included in a plurality of artificial intelligence models, wherein each artificial intelligence model of the plurality of artificial intelligence models are trained on a separate training dataset of a plurality of training datasets, wherein each training dataset of the plurality of training datasets are specific to a corresponding field of the one or more second fields, and wherein the method further comprises generating the plurality of artificial intelligence models by training each artificial intelligence model of the plurality of artificial intelligence models using the plurality of training datasets.

13. The method of claim 8, wherein the first artificial intelligence model comprises a first large language model and the second artificial intelligence model comprises a second large language model, wherein the first large language model has a same base model as the second large language model, and wherein the first large language model is trained using a first training process that is different than a second training process.

14. The method of claim 8, further comprising controlling a subsequent interaction using the adjusted target report, wherein the subsequent interaction comprises a second interaction that is different than the interaction between the first entity and the second entity, and wherein the subsequent interaction involves the first entity or the second entity.

15. A non-transitory computer-readable medium comprising program code executable by a processing device for causing the processing device to perform operations comprising:
receiving data comprising first confidential information about an interaction between a first entity and a second entity, the interaction involving a first plurality of fields for receiving the first confidential information;
determining a target report to generate based at least in part on the first confidential information;
identifying one or more second fields of the target report and corresponding to the first plurality of fields, the one or more second fields comprising second confidential information about the interaction, the second confidential information different from the first confidential information;
executing, to generate adjusted second confidential information, a first artificial intelligence model on the one or more second fields to ascertain a security likelihood associated with the second confidential information;
determining a security level for the adjusted second confidential information based at least in part on the security likelihood;
in accordance with the security level not exceeding a threshold security value, executing, to generate further adjusted second confidential information, a second artificial intelligence model on the one or more second fields to adjust the security likelihood; and
adjusting the target report using the adjusted second confidential information or the further adjusted second confidential information.

16. The non-transitory computer-readable medium of claim 15, wherein the first artificial intelligence model and the second artificial intelligence model are included in a plurality of artificial intelligence models, wherein each artificial intelligence model of the plurality of artificial intelligence models corresponds with a different field of the one or more second fields, and wherein the operation of executing the first artificial intelligence model on the one or more second fields comprises, for each field of the one or more second fields:
identifying a particular artificial intelligence model of the plurality of artificial intelligence models that corresponds with the field; and
executing the particular artificial intelligence model on the field to determine a corresponding security level of data included in the field.

17. The non-transitory computer-readable medium of claim 15, wherein the operations further comprise:
executing a third artificial intelligence model on the one or more second fields to adjust the second confidential information;
determining an error rate for the adjusted second confidential information; and
in accordance with the error rate exceeding a threshold error rate, executing a fourth artificial intelligence model on the one or more second fields to further adjust the second confidential information.

18. The non-transitory computer-readable medium of claim 17, wherein the first artificial intelligence model and the second artificial intelligence model are included in a plurality of artificial intelligence models, wherein each artificial intelligence model of the plurality of artificial intelligence models are trainable on a separate training dataset of a plurality of training datasets, wherein each training dataset of the plurality of training datasets are specific to a corresponding field of the one or more second fields, and wherein the operations further comprise generating, using a computer service, the plurality of artificial intelligence models by training each artificial intelligence model of the plurality of artificial intelligence models using the plurality of training datasets.

19. The non-transitory computer-readable medium of claim 15, wherein the first artificial intelligence model comprises a first large language model and the second artificial intelligence model comprises a second large language model, wherein the first large language model has a same base model as the second large language model, and wherein the first large language model is trainable using a first training process that is different than a second training process.

20. The non-transitory computer-readable medium of claim 15, wherein the operations further comprise controlling a subsequent interaction using the adjusted target report, wherein the subsequent interaction comprises a second interaction that is different than the interaction between the first entity and the second entity, and wherein the subsequent interaction involves the first entity or the second entity.
